(19) United States
(12) Patent Application Publication
(10) Pub. No.: US 2007/0084012 A1
(43) Pub. Date: Apr. 19, 2007

(54) Noise-reducing plug, and door assembly including the same

(75) Inventors: Normand Savard, Drummondville (CA); Yannick Funk, Drummondville (CA); Pierre-Louis Foucault, St-Lambert (CA); Jean-Philippe Boulianne, Lennoxville (CA); Pierre Luc Houle, Becancour (CA)

Correspondence Address: MERCHANT & GOULD PC, P.O. BOX 2903, MINNEAPOLIS, MN, 55402-0903, US

(73) Assignee: CANIMEX INC., Drummondville (CA)

(21) Appl. No.: 11/403,281

(22) Filed: Apr. 12, 2006

(30) Foreign Application Priority Data
Apr. 13, 2005 (CA) 2,504,030

(51) Int. Cl. E05D 13/00

(52) U.S. Cl. 16/197

(57) ABSTRACT

A plug for operatively connecting an extremity of a torsion spring to another corresponding component of a counterbalancing assembly. The plug includes a collar and at least one connecting flange. The collar defines a longitudinal axis, and includes first and second opposite ends, the collar being shaped and sized for removably mounting onto the extremity of the torsion spring. Each connecting flange is provided on the first end of the collar for connecting the plug onto the corresponding component of the counterbalancing assembly. The improvement lies in that the collar has first and second sections, the first section being adjacent to the first end of the collar and having a peripheral surface being provided with threading for threadedly engaging the extremity of the torsion spring, and the second section being adjacent to the second end of the collar and having a peripheral surface being tapered with respect to the peripheral surface of the first section so as to minimize interference with an internal portion of the torsion spring when the collar is removably mounted onto the extremity of the torsion spring.

### FIELD OF THE INVENTION

The present invention relates to a plug, such as the ones used in counterbalancing systems of door assemblies and the like. More particularly, in its preferred intended use, the present invention relates to a noise-reducing plug, and also relates to a door assembly including the same.

### BACKGROUND OF THE INVENTION

Garage doors and the like are well known in the art. Indeed, it is well known in the art that garage doors usually require to be connected to a counterbalancing system for counterbalancing the weight of the door in order to decrease the force required to open the door and also safely facilitate its closing from a raised to a lowered position. Counterbalancing systems can be found in many other types of cable-operated doors, such as slidable truck doors, for example.

It is also known in the art that a widely used type of counterbalancing system generally comprises a pair of spaced apart cable drums connected to corresponding cables, each cable being in turn connected to a lower opposite side edge of the garage door. The cable drums are usually mounted on an overhead shaft which is typically supported above the door opening and is connected to one or more torsion springs which are each fixed to the shaft at one end, and operatively secured to a fixed structure such as the wall, or a wall bracket, for example, at the other end, so that the cable drums are biased to rotate in a direction which winds the cables onto the drums and counteracts the weight of the door connected to the cables. The torsion springs are adjusted to properly balance the weight of the door so that minimal opening and closing efforts are required, either manually or when motor controlled.

It is also known in the art that conventional, low cost adjustment devices used for the above-mentioned type of counterbalancing system, and widely utilized in the garage door industry, are generally cylindrical “anchors” commonly referred to also as “plugs” (“collars”, “cones”, etc.) which are connected to the ends of the torsion springs and are thus mounted on the aforementioned shaft for adjusting the deflection of the springs to preset the torsional (or counterbalancing) force of the spring.

In operation, torque is transferred between the torsion spring, overhead shaft, and anchors or plugs, which operatively connect the shaft to the spring, in order to counterbalance the weight of the garage door. Usually, each torsion spring is fixed to the overhead shaft at one end, by means of a plug known as a “winding plug”, and operatively secured to the wall via a bracket at the other end, by means of another plug known as a “stationary plug”.

Large, vertical opening door assemblies, such as commercial and residential sectional garage doors, also usually require mechanisms to counterbalance the weight of the door in order to minimize door opening efforts and to control movement of the door from an opened to a closed position. Large sectional garage doors for commercial and residential applications may be manually or power operated. In either case, but particularly for manual operation, counterbalancing mechanisms have been used for many years to counterbalance the weight of the door and control its opening and closing movements so that one person can easily control operation of the door. Counterbalancing mechanisms are also advantageous for power operated vertical opening doors since they reduce motor power requirements and the required strength of the door opening and closing mechanism. In other words, lighter weight, lower cost, door control mechanisms may be used if a counterbalancing mechanism is connected to the door to assist the opening and closing actions.

The Assignee of the present application has developed several plugs and devices to be used with door assemblies and the like, several of which are described in the following U.S. patents and patent applications: U.S. Pat. Nos. 6,174,575 B1; 6,279,268 B1; 6,378,170 B1; 6,485,006 B1; 6,502,281 B2; 6,681,809 B2; 6,694,673 B2; 6,712,116 B2; 6,907,964 B2; 6,931,810 B2; 6,959,751 B2; 6,986,378 B2; 6,988,527 B2; 7,000,292 B2; 7,000,354 B2; D490,685 S; 2002/0117787 A1; 2003/0198790 A1; 2004/0000109 A1; 2004/0020609 A1; 2004/0124050 A1; 2005/0006545 A1; and 2005/0183341 A1, the contents of which are incorporated herein by reference.

As previously mentioned, it is known in the art that a widely used type of counterbalancing assembly or mechanism comprises, generally, a pair of spaced apart cable drums connected to corresponding cables, which in turn are connected to lower and opposite edges of the garage door. The cable drums are usually mounted on a shaft which is generally supported above the door opening, as better shown in FIG. 1, and is connected to one or more torsion springs which are fixed at one end to the shaft and are operatively secured to the wall at the opposite end so that the cable drums are biased to rotate in a direction which winds the cables onto the drum and counteracts the weight of the door connected to the cables. The torsion springs are adjusted to properly balance the weight of the door so that minimal opening and closing efforts are required, either manually or motor controlled.

As also previously mentioned, a conventional, low cost adjustment mechanism for the above-mentioned type of counterbalancing assembly, and widely used in the door industry, is characterized by generally cylindrical collars commonly referred to also as “plugs” (or “cones”) which are connected to the so-called fixed ends of the torsion springs and are mounted on the aforementioned shaft for adjusting the deflection of the springs to preset the counterbalance effort. The aforementioned collars usually include one or more setscrews which lock the collars to the shaft to prevent rotation except during adjustment of the spring deflection. The collars also generally include sockets for receiving winding bars whereby the springs are manually preset by rotating the collars using the winding bars and then locking the collars to the shaft, typically with the setscrews.

It is also well known in the art that a drawback associated with the above-described type of counterbalancing assembly, or with any other type of counterbalancing mechanism which employs winding collars and tension springs, is the noticeable and unwanted noise which is generally generated by the spring and the corresponding anchoring device (i.e. “plug”).

Hence, in light of the aforementioned, there is a need for an improved anchoring device (or “plug”) which, by virtue of its design and components, would be able to overcome some of the aforementioned prior art problems, namely to substantially reduce the noise which is generally associated with the interaction of the device with a torsion spring of a conventional door assembly.

### SUMMARY OF THE INVENTION

The object of the present invention is to provide a plug (also known as “anchor”, “collar”, “cone”, etc.) which, by virtue of its design and components, satisfies some of the above-mentioned needs and is thus an improvement over other related plugs known in the prior art.

The present invention is particularly advantageous in that it is intended for minimizing unwanted noise which is generally associated with similar plugs of the prior art.

In accordance with the present invention, the above object is achieved, as will be easily understood, with a plug such as the one briefly described herein and such as the one exemplified in the accompanying drawings.

More particularly, according to the present invention, there is provided a plug for operatively connecting an extremity of a torsion spring to another corresponding component of a counterbalancing assembly, the plug comprising:
a collar defining a longitudinal axis, and comprising first and second opposite ends, said collar being shaped and sized for removably mounting onto the extremity of the torsion spring;
at least one connecting flange provided on the first end of the collar for connecting the plug onto the corresponding component of the counterbalancing assembly;
   the improvement wherein:
the collar comprises first and second sections, the first section being adjacent to the first end of the collar and having a peripheral surface being provided with threading for threadedly engaging the extremity of the torsion spring, and the second section being adjacent to the second end of the collar and having a peripheral surface being tapered with respect to the peripheral surface of the first section so as to minimize interference with an internal portion of the torsion spring when the collar is removably mounted onto the extremity of said torsion spring.

According to another aspect of the present invention, there is also provided a noise-reducing plug for operatively connecting an extremity of a torsion spring to another corresponding component of a counterbalancing assembly, the plug comprising:
a collar defining a longitudinal axis, and comprising first and second opposite ends, said collar being shaped and sized for removably mounting onto the extremity of the torsion spring;
at least one connecting flange provided on the first end of the collar for connecting the plug onto the corresponding component of the counterbalancing assembly;
   the improvement wherein:
the collar comprises first and second sections, the first section being adjacent to the first end of the collar and having a peripheral surface being provided with threading for threadedly engaging the extremity of the torsion spring, and the second section being adjacent to the second end of the collar and having a peripheral surface being tapered with respect to the peripheral surface of the first section so as to minimize interference with an internal portion of the torsion spring and noise resulting from such interference when the collar is removably mounted onto the extremity of said torsion spring.

Preferably, the peripheral area of the first section of the collar defines a first slope, and the peripheral area of the second section of the collar defines a second slope different from the first slope.

Preferably also, the first slope defines a first angle with respect to the longitudinal axis of the collar, and the second slope defines a second angle with respect to the longitudinal axis of the collar, the second angle being greater than the first angle.

Preferably also, the first angle is about 6 degrees, and the second angle is about 12 degrees.

Preferably also, the threading provided on the first section of the collar defines grooves for receiving at least one coil of the extremity of the torsion spring.

Preferably also, the threading provided on the first section of the collar defines grooves for receiving a plurality of coils of the extremity of the torsion spring.

Preferably also, the collar is substantially cylindrical and the second section of the collar is substantially tapered inwardly towards the longitudinal axis of the collar, with respect to the first section of said collar.

Preferably also, when the plug is a “winding plug”, the at least one flange is provided with at least one socket for receiving a winding tool.

Preferably also, the collar, the at least one flange and the threading are made integral to each other.

According to another aspect of the invention, there is also provided a driving (or “counterbalancing”) system provided with the above-mentioned plug.

According to yet another aspect of the invention, there is also provided a door assembly provided with the above-mentioned plug and/or driving (or “counterbalancing”) system.

According to yet another aspect of the invention, there is also provided a method of installing the above-mentioned plug onto the above-mentioned system and/or door assembly.

According to yet another aspect of the invention, there is also provided a method of manufacturing the above-mentioned plug.

The objects, advantages and other features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a perspective view of a door assembly according to the prior art.

FIGS. 2a and 2b are respectively perspective views of winding and stationary plugs according to the prior art.

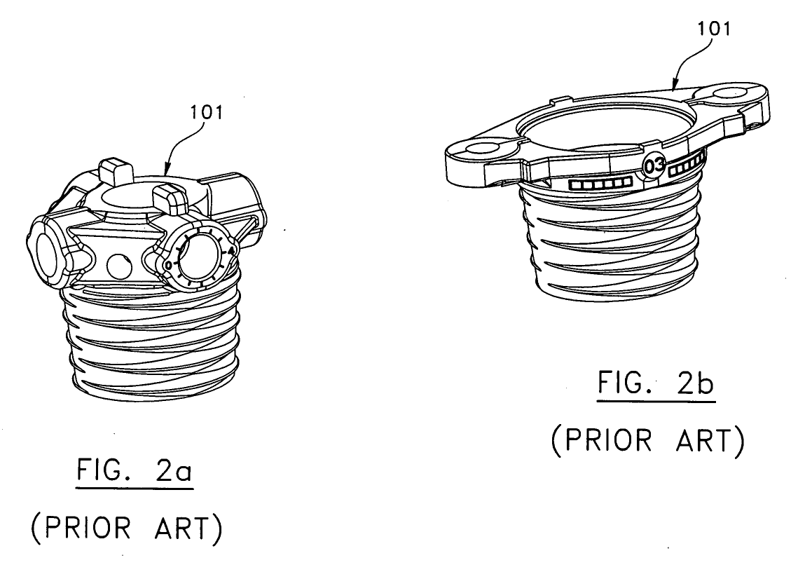

FIGS. 3a and 3b are respectively perspective views of winding and stationary plugs according to preferred embodiments of the present invention.

FIG. 4 is a sectional view of a counterbalancing spring provided with the prior art winding and stationary plugs of FIG. 2, said plugs being shown mounted and cooperating with respective extremities of the spring before a winding operation.

FIG. 5 is another view of what is shown in FIG. 4, the counterbalancing spring being now shown after a winding operation.

FIG. 6 is another view of what is shown in FIG. 4, the counterbalancing spring being now shown provided with stationary and winding plugs according to preferred embodiments of the present invention.

FIG. 7 is another view of what is shown in FIG. 6, the counterbalancing spring being now shown after a winding operation.

### DETAILED DESCRIPTION OF PREFERRED EMBODIMENTS OF THE INVENTION

In the following description, the same numerical references refer to similar elements. The embodiments shown in the figures are preferred, for exemplification purposes only.

In the context of the present description, the expression “garage door” includes all types of cable-operated doors and the like. Although the present invention was primarily designed for a garage door, it may be used with other kinds of doors, such as slidable truck doors, or with any other items using a driving/counterbalancing system, as apparent to a person skilled in the art. For this reason, the expression “garage door” should not be taken as to limit the scope of the present invention and includes all other kinds of doors or items with which the present invention may be used and could be useful.

Moreover, in the context of the present description, the expressions “garage” and “door”, “torsion spring”, “torsional spring” and “counterbalancing spring”, “counterbalancing shaft” and “overhead shaft”, “counterbalancing mechanism” and “counterbalancing system”, as well as any other equivalent expressions and/or compound words thereof, may be used interchangeably. The same applies for any other mutually equivalent expressions, such as “anchor”, “plug”, “collar” and “cone” for example, as well as “system”, “assembly”, “device” and “mechanism”, as apparent to a person skilled in the art.

In addition, although the preferred embodiment of the present invention as illustrated in the accompanying drawings comprises various components and although the preferred embodiment of the plug 1 (or “anchor” 1) and corresponding parts of the present invention as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the plug 1 (“anchor” 1) according to the present invention, as will be briefly explained herein and as can be easily inferred herefrom by a person skilled in the art, without departing from the scope of the invention.

Broadly described, the plug 1 according to the present invention, as exemplified in the accompanying drawings, is a plug 1 for use with a counterbalancing system 3 of a door assembly 5, such as a garage door for example, for operatively connecting a torsion spring 7 to another corresponding component of the door assembly 5, such as an overhead shaft 9 for example, and/or the like, in order to allow a proper torque transfer between the torsion spring 7 and the corresponding component via the plug 1, as is well known in the art.

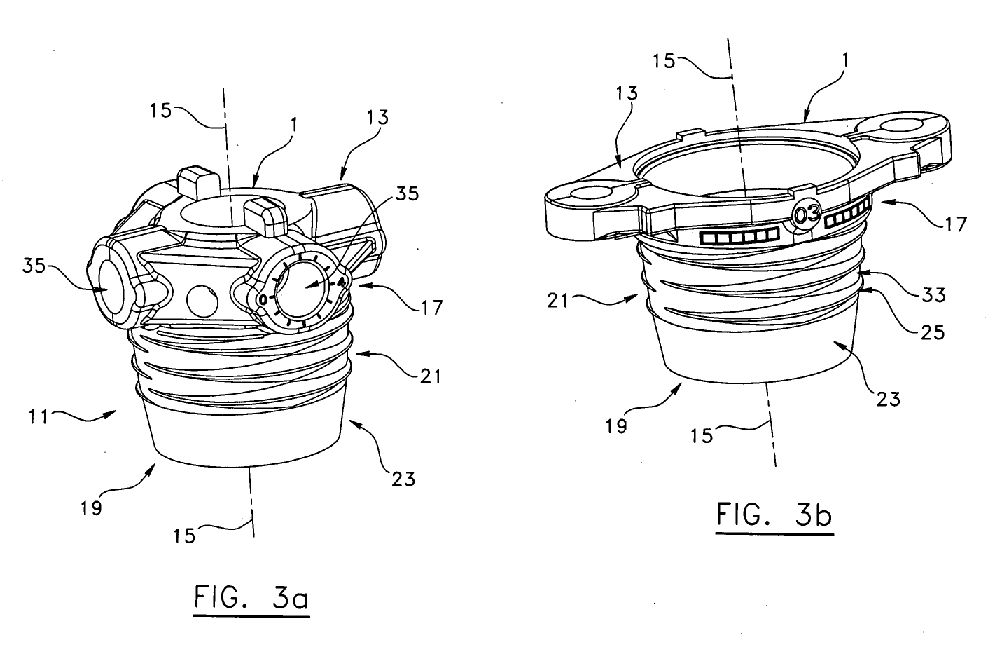

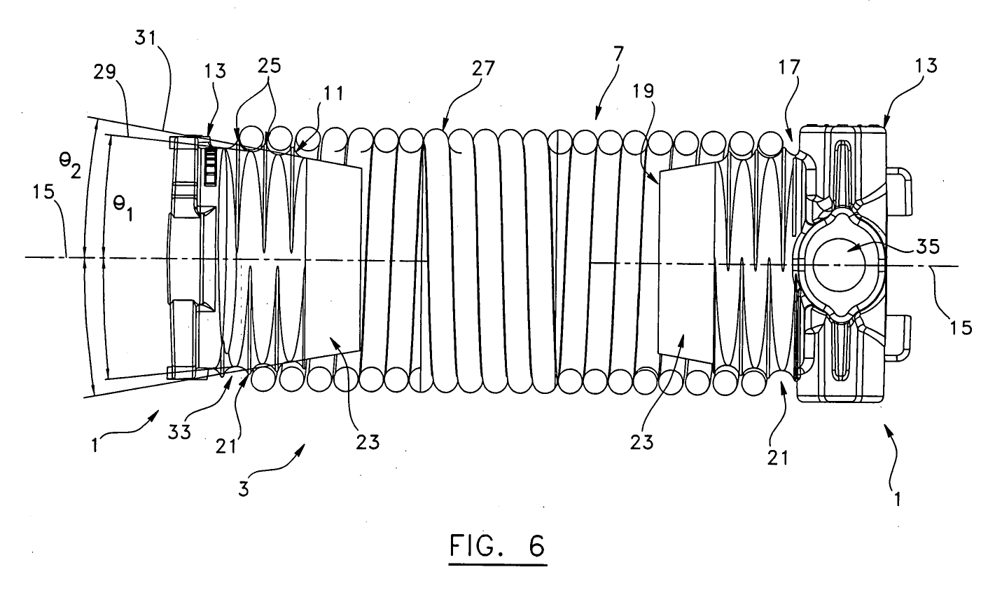

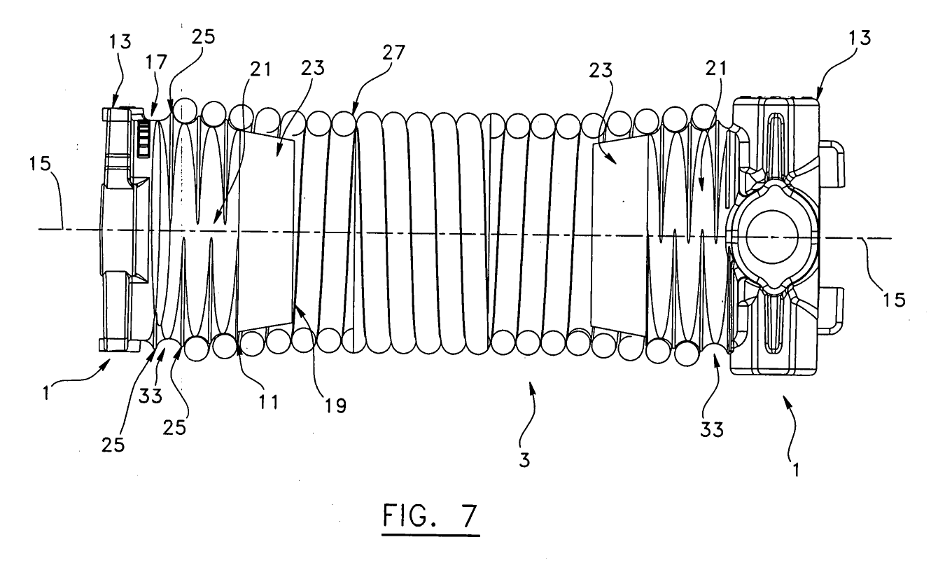

The plug 1 is used for operatively connecting an extremity of a torsion spring 7 to another corresponding component of the door assembly 5 and comprises a collar 11, and at least one connecting flange 13, as better exemplified in FIGS. 3a and 3b. As also shown, the collar 11 defines a longitudinal axis 15 (i.e. an “imaginary” longitudinal axis 15, as can be easily understood by a person skilled in the art), and comprises first and second opposite ends 17,19, the collar 11 being shaped and sized for removably mounting onto the extremity of the torsion spring 7, as better exemplified in FIGS. 6 and 7. Preferably also, the at least one connecting flange 13 of the plug 1 is provided on the first end 17 of the collar 11 for appropriately connecting the plug 1 onto the corresponding component of the counterbalancing assembly 3, as is well known in the art. An important aspect of the present invention resides in the fact that the collar 11 comprises first and second sections 21,23, the first section 21 being adjacent to the first end 17 of the collar 11 and having a peripheral surface being provided with threading 25 for threadedly engaging the extremity of the torsional spring 7, and the second section 23 being adjacent to the second end 19 of the collar 11 and having a peripheral surface being tapered with respect to the peripheral surface of the first section 21 so as to minimize interference with an internal portion of the torsion spring 7, namely inner coils 27 thereof, when the collar 11 is removably mounted onto the extremity of said torsion spring 7, as better shown in FIGS. 6 and 7, and as can be easily understood therefrom by a person skilled in the art.

It is worth mentioning at this stage that other suitable means, other than threadings 25 for example, could be used according to the present invention in order to properly and removably secure the collar 11 of the plug 1 onto the extremity of the torsion spring 7, examples of which are hooks, clips, and the like, as is well known in the art. Indeed, as can be better appreciated from the present description, an important aspect of the invention resides in the fact that the collar 11 comprises two “distinct” first and second sections 21,23, the second section 23 being tapered with respect to the first section 21, so as to minimize or avoid completely if possible interference with an internal portion of the torsion spring 7 when the collar 11 of the plug 1 is mounted onto the extremity of said spring 7 during normal counterbalancing functions, as better shown in FIG. 7 and as can be easily understood by a person skilled in the art.

According to a preferred embodiment of the present invention, and as better exemplified in FIG. 6, the peripheral area of the first section 21 of the collar 11 defines a first slope 29, and the peripheral area of the second section 23 of the collar 11 defines a second slope 31 which is different from the first slope 29. Preferably also, the first slope 29 defines a first angle θ₁ with respect to the longitudinal axis 15 of the collar 11, and the second slope 31 defines a second angle θ₂ with respect to the longitudinal axis 15 of the collar 11, the second angle θ₂ being greater than the first angle θ₁, as also better illustrated in FIG. 6.

According to another preferred embodiment of the present invention, the above-mentioned first angle θ₁ is preferably about 6 degrees, whereas the second angle θ₂ is preferably about 12 degrees. It is worth mentioning that other suitable ranges of degrees and/or ratios of degrees could be used according to the present invention, in order to attain the features and advantages described herein, as can also be easily understood by a person skilled in the art.

As better shown in FIGS. 3a and 3b, the threading 25 is preferably provided on the first section 21 of the collar 11 so as to define at least one groove 33 for receiving a corresponding coil 27 of the extremity of the torsion spring 7. Preferably, a plurality of grooves 33 are defined in order to receive a plurality of coils 27 of the extremity of the torsion spring 7, as better shown in FIGS. 6 and 7.

Furthermore, and as better shown in FIGS. 3a and 3b, the collar 11 is preferably substantially cylindrical and the second section 23 of the collar 11 is substantially tapered inwardly towards the longitudinal axis 15 of the collar 11, with respect to the first section 21 of said collar 11, as can be better understood when referring to FIGS. 6 and 7.

In the event that the plug 1 is being used as a “winding plug” 1, such as the one exemplified in FIG. 3a, each flange 13 of the collar 11 is preferably provided with a suitable socket 35 for receiving a winding tool, such as a winding bar, in order to preset a predetermined amount of torque in the torsional spring 7 via the plug 1, as is known in the art.

Preferably also, the different components of the plug 1, namely the collar 11, each flange 13 and threading 25, are preferably made integral to each other, that is are preferably made of one single material and one single piece, via a suitable and cost-effective manufacturing process, as can be easily understood by a person skilled in the art.

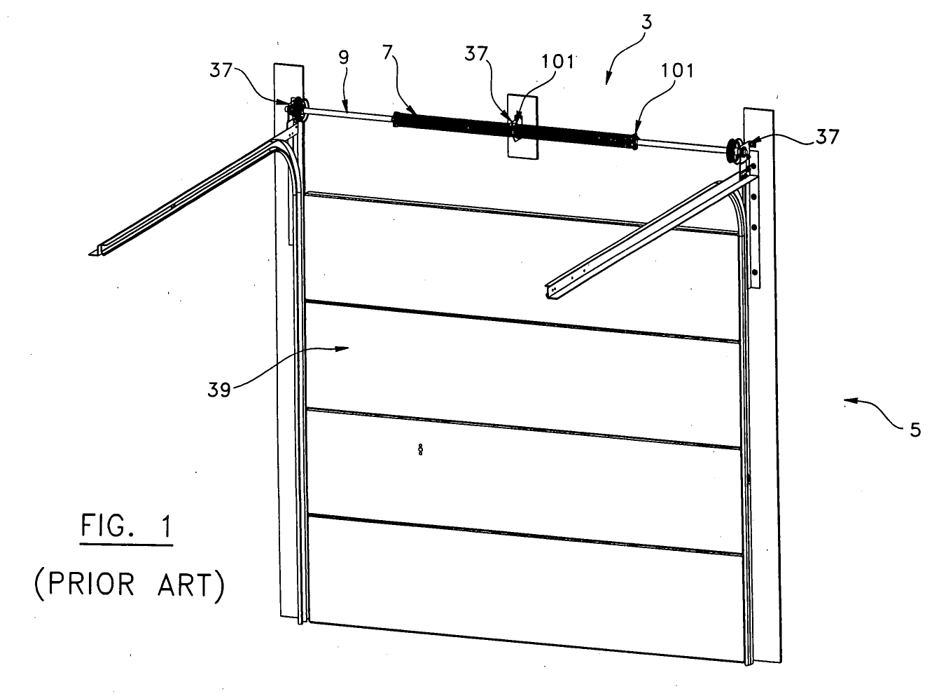

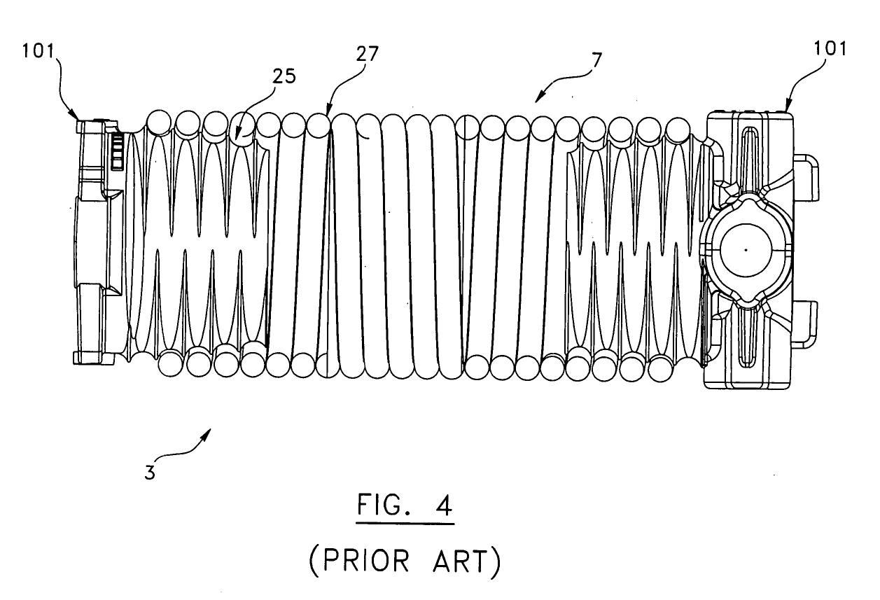

As better shown in the accompanying drawings, and particularly in FIG. 1, the plug 1 is configured for use with the counterbalancing system 3 of the door assembly which, among other components, typically includes a rotatable overhead shaft 9 operatively connected to the door for operating the same; the plug 1 or anchor being mounted about the overhead shaft 9 and being rotatable thereabout; drums 41 at the extremities of the shaft 9; and a torsional spring 7 operatively connecting the plug 1 to the overhead shaft 9 and being loaded thereinbetween so as to exert a torsional force capable of counterbalancing the weight of the door, the torsional force being transmittable between the overhead shaft 9 and the torsional spring 7 via the plug 1, as can be easily understood when referring to FIGS. 4-7. Counterbalancing systems 3 of garage doors are very well known in the art and thus, in the context of the present description, there is no need to further explain the working principle thereof, as apparent to a person skilled in the art.

The plug 1, anchoring device or fastening system according to the present invention is preferably used in a corresponding counterbalancing system 3, such as the one used for a typical garage door assembly 5, as exemplified in FIG. 4. It is worth mentioning that the fastening system can also be used in any other door assemblies and/or arrangements, such as those of truck doors and the like.

Referring particularly to FIG. 1, there is shown an example of a typical counterbalancing system 3 which may be currently found on the market. It is worth mentioning that other models operating on a similar working principles are also available and known in the prior art. The counterbalancing system 3 illustrated in FIG. 1 comprises a pair of opposite torsional springs 7 that are coaxially mounted about and around an overhead shaft 9. As is well known in the art, one end of each spring 7 is generally connected to a central bracket 37 by means of a first plug 101, known as a “stationary plug” 101, and the central bracket 37 is generally attached to a fixed structure, such as the garage wall. The other end of each spring 7 is generally operatively connected to the shaft 9 by means of a second plug 101, also known as the “winding plug” 101. This second or winding plug 101 is at least fixed in rotation with respect to the shaft 9, usually with setscrews, once the system 3 has been properly balanced and adjusted.

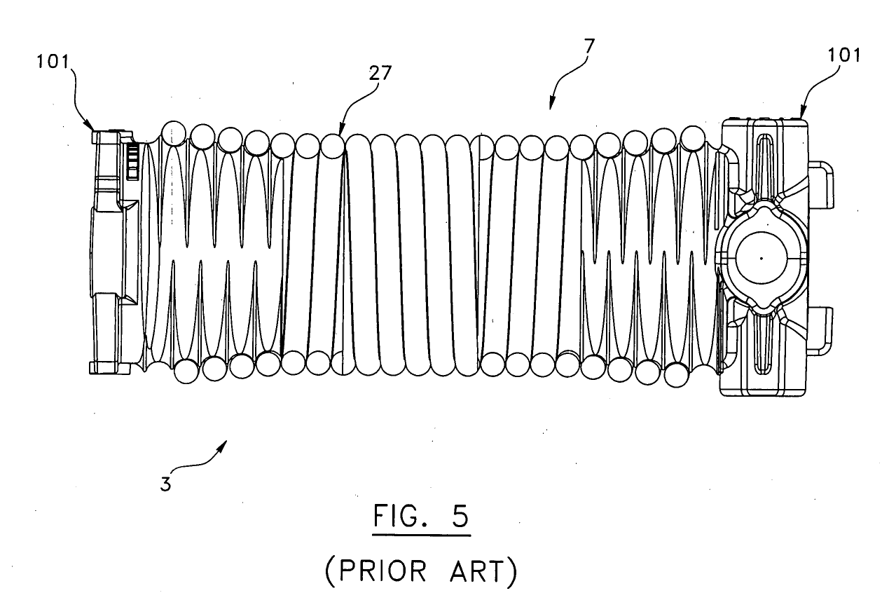

In normal operation, when the door 39 is opened, the torque generated by the spring 7 through anchors and shaft 9, reduces the effort required to lift and close the door 39. Thus, when the door 39 is opened, spring 7 unwinds, and thus, the inside diameter of spring 7 is increased, as better exemplified in FIG. 4. On the contrary, when the door 39 is closed, an energy of the door 39 is accumulated into springs 7 by means of a winding thereof. As can be easily understood when referring to FIG. 5, the inside diameter of spring 7 is thus reduced to the point that it generally touches the last threaded section(s) of a conventional plug 101. This contact with the threaded section(s) of a conventional plug 101 generally generates a substantial friction between the coil 27 of the spring 7 and the corresponding anchor with which it rubs, as well as a substantial friction between the coil 27 of the spring 7 with an adjoining or neighboring other coil 27 of the spring 7, which in turn generates substantial noise and/or wear, which are obviously undesirable, for obvious reasons known in the art.

The anchoring plug 1, whether stationary or winding, according to the preferred embodiments of the present invention, as better exemplified in FIGS. 3a and 3b, is preferably designed with at least two separate sections 21, 23 on the collar 11 or “cone”, a first section 21 being provided with corresponding threading 25 for mounting and installing each plug 1 into a corresponding end of the torsional spring 7, in a manner well known in the art, and the second section 23 being preferably deprived of any threads, and preferably also, at a corresponding sloping angle, so as to prevent the adverse effects mentioned above which generally result between a friction of the latter portions of threadings of a conventional plug 101 and the corresponding torsional spring 7. Thus, this new designed plug 1, whether stationary and/or winding plug 1, according to the present invention, is preferably devised so as to allow a movement in the spring 7 even after winding thereof. Indeed, FIG. 7 exemplifies how there is room allowed between the coil 27 of the spring 7 and the non-threaded section 23 of the plug 1 according to the present invention, and after a winding operation. Preferably, the exact end collar dimensions and corresponding geometrical configurations, as well as corresponding slopes 29,31 of the given sections 21,23, are preferably calculated in function of the final dimension of the spring 7 to be wound about the given plug 1.

It is worth mentioning that another important aspect of the present invention to be considered resides in the dimension of the diameter of the plug 1 at the first threaded section 21 of the plug 1 in order to maximize a given friction between the coil 27 and the plug 1 in order to properly hold the spring 7 during normal operation. This dimension is preferably optimized in order to reduce effort to insert the plug 1 onto the spring 7, prior to the installation, but so as to ensure a good operation of the system 3, as is well known in the art.

According to the preferred embodiment of the present invention, there is preferably provided a double-angle configuration on the collar's outer surface, as better exemplified in FIG. 6, which is also a critical way for this preferred design to facilitate insertion of the plug, whether stationary and/or winding, onto a given spring 7, so as to not only allow to reduce the required quantity of material for manufacturing the given product, but also play an important role in noise reduction of the spring 7 in a given counterbalancing assembly 3, during normal operation, as indicated by laboratory tests carried out by the Assignee.

Thus, it is worth mentioning that according to the present invention, there is preferably provided an anchoring plug 1 for use with a spring 7 in a counterbalancing system 3, and particularly used in the garage door industry, which is preferably composed by a collar 11 or “cone” with a first section 21 which is threaded in a manner to interact with a given torsional spring 7 as is well known in the art, but also having a second section 23 which is preferably deprived of such threadings 25, and/or at “an angle”, so as to minimize adverse effects which are generally to be expected with conventional anchoring devices 101.

According to another important aspect of the present invention, there is also preferably provided an anchoring plug 1 composed of a double-angle configuration cone with a first section 21 threaded, and a second section 23 not threaded, as explained above, each of these sections 21,23 being preferably at different sloping angles from each other, as better exemplified in FIG. 6.

The plug 1 and corresponding parts are preferably made of substantially rigid materials, such as metallic materials (steel, etc.), hardened polymers, composite materials, and/or the like, so as to ensure a proper operation thereof depending on the particular applications for which the plug 1 is intended and the different parameters in cause (counterbalancing force in the spring, weight of the door, etc.), as apparent to a person skilled in the art.

Moreover, it is worth noting that according to the present invention several modifications could be made to the plug 1 described and illustrated herein, without departing from the scope of the present invention, as apparent to a person skilled in the art. For example, a) the plug 1 can be shaped and sized to be installed on any torsion spring dimensions (diameter) on which a conventional plug can be installed; and/or b) the plug 1 could be provided with more than two separate sections 21,23, each of which could be provided with corresponding threadings 25 or not, and at different sloping angles or not, depending on the particular applications for which the plug 1 is intended and the corresponding torsional spring with which it is supposed to cooperate, as can be easily understood by said person skilled in the art.

The present invention is an improvement and presents several advantages over devices known in the prior art. Indeed, the present invention may be used in the garage door industry, with new garage doors or existing garage doors. The present invention is also particularly advantageous in that, as briefly explained hereinabove, the plug 1 enables to minimize adverse effects, namely noise and unwanted friction, which generally are to be expected with conventional anchors, due to the provision of a second separate section 23 deprived of any threadings 25, and preferably at an angle with respect to the threaded first section 21. Indeed, as may now be better appreciated, and in the context of the present description, the fact that the second section 23 of the collar is “tapered” with respect to the first section 21 thereof can also mean and include the possibility of the second section 23 being simply a continuous extension of the first section 21, yet “distinct”, in that it could simply be deprived of threading 25, so as to minimize or avoid interference of said second section 23, with an internal portion of the torsion spring 7 during a normal operating configuration. Furthermore, the present invention is also advantageous in that it may be used with other kinds of doors, such as slidable truck doors, or with any other items provided with counterbalancing mechanisms 3 such as the aforementioned, as apparent to a person skilled in the art.

Of course, numerous modifications could be made to the above-described embodiments without departing from the scope of the invention, as defined in the appended claims.

1. A plug for operatively connecting an extremity of a torsion spring to another corresponding component of a counterbalancing assembly, the plug comprising:
a collar defining a longitudinal axis, and comprising first and second opposite ends, said collar being shaped and sized for removably mounting onto the extremity of the torsion spring;
at least one connecting flange provided on the first end of the collar for connecting the plug onto the corresponding component of the counterbalancing assembly;
the improvement wherein:
the collar comprises first and second sections, the first section being adjacent to the first end of the collar and having a peripheral surface being provided with threading for threadedly engaging the extremity of the torsion spring, and the second section being adjacent to the second end of the collar and having a peripheral surface being tapered with respect to the peripheral surface of the first section so as to minimize interference with an internal portion of the torsion spring when the collar is removably mounted onto the extremity of said torsion spring.

2. A plug according to claim 1, wherein the peripheral area of the first section of the collar defines a first slope, and wherein the peripheral area of the second section of the collar defines a second slope different from the first slope.

3. A plug according to claim 2, wherein the first slope defines a first angle with respect to the longitudinal axis of the collar, and wherein the second slope defines a second angle with respect to the longitudinal axis of the collar, said second angle being greater than the first angle.

4. A plug according to claim 3, wherein the first angle is about 6 degrees.

5. A plug according to claim 3, wherein the second angle is about 12 degrees.

6. A plug according to claim 1, wherein the threading provided on the first section of the collar defines grooves for receiving at least one coil of the extremity of the torsion spring.

7. A plug according to claim 1, wherein the threading provided on the first section of the collar defines grooves for receiving a plurality of coils of the extremity of the torsion spring.

8. A plug according to claim 1, wherein the collar is substantially cylindrical and wherein the second section of the collar is substantially tapered inwardly towards the longitudinal axis of the collar, with respect to the first section of said collar.

9. A plug according to claim 1, wherein the at least one flange is provided with at least one socket for receiving a winding tool.

10. A plug according to claim 1, wherein the collar, the at least one flange and the threading are made integral to each other.

11. A noise-reducing plug for operatively connecting an extremity of a torsion spring to another corresponding component of a counterbalancing assembly, the plug comprising:
a collar defining a longitudinal axis, and comprising first and second opposite ends, said collar being shaped and sized for removably mounting onto the extremity of the torsion spring;
at least one connecting flange provided on the first end of the collar for connecting the plug onto the corresponding component of the counterbalancing assembly;
the improvement wherein:
the collar comprises first and second sections, the first section being adjacent to the first end of the collar and having a peripheral surface being provided with threading for threadedly engaging the extremity of the torsion spring, and the second section being adjacent to the second end of the collar and having a peripheral surface being tapered with respect to the peripheral surface of the first section so as to minimize interference with an internal portion of the torsion spring and noise resulting from such interference when the collar is removably mounted onto the extremity of said torsion spring.

12. A door assembly having a counterbalancing assembly comprising a torsion spring and a plug for operatively connecting an extremity of the torsion spring to another corresponding component of the counterbalancing assembly, the plug comprising:
a collar defining a longitudinal axis, and comprising first and second opposite ends, said collar being shaped and sized for removably mounting onto the extremity of the torsion spring;
at least one connecting flange provided on the first end of the collar for connecting the plug onto the corresponding component of the counterbalancing assembly;
the improvement wherein:
the collar comprises first and second sections, the first section being adjacent to the first end of the collar and having a peripheral surface being provided with threading for threadedly engaging the extremity of the torsion spring, and the second section being adjacent to the second end of the collar and having a peripheral surface being tapered with respect to the peripheral surface of the first section so as to minimize interference with an internal portion of the torsion spring when the collar is removably mounted onto the extremity of said torsion spring.

13. A door assembly according to claim 12, wherein the peripheral area of the first section of the collar defines a first slope, and wherein the peripheral area of the second section of the collar defines a second slope different from the first slope.

14. A door assembly according to claim 13, wherein the first slope defines a first angle with respect to the longitudinal axis of the collar, and wherein the second slope defines a second angle with respect to the longitudinal axis of the collar, said second angle being greater than the first angle.

15. A door assembly according to claim 14, wherein the first angle is about 6 degrees, and wherein the second angle is about 12 degrees.

16. A door assembly according to claim 12, wherein the threading provided on the first section of the collar defines grooves for receiving at least one coil of the extremity of the torsion spring.

17. A door assembly according to claim 12, wherein the threading provided on the first section of the collar defines grooves for receiving a plurality of coils of the extremity of the torsion spring.

18. A door assembly according to claim 12, wherein the collar is substantially cylindrical and wherein the second section of the collar is substantially tapered inwardly towards the longitudinal axis of the collar, with respect to the first section of said collar.

19. A door assembly according to claim 12, wherein the at least one flange is provided with at least one socket for receiving a winding tool.

20. A door assembly according to claim 12, wherein the collar, the at least one flange and the threading are made integral to each other.
